(19) United States
(12) Patent Application Publication
(10) Pub. No.: US 2022/0150135 A1
(43) Pub. Date: May 12, 2022

(54) INFORMATION PROCESSING APPARATUS, INFORMATION PROCESSING METHOD, AND PROGRAM

(71) Applicant: Sony Group Corporation, Tokyo (JP)

(72) Inventors: Kazunori SAKAKI, Tokyo (JP); Yuta CHOKI, Tokyo (JP); Vijitha RANATUNGA, Tokyo (JP); Yoshihiro KOSAKA, Tokyo (JP)

(73) Assignee: Sony Group Corporation, Tokyo (JP)

(21) Appl. No.: 17/431,909

(22) PCT Filed: Sep. 2, 2020
(86) PCT No.: PCT/JP2020/033199

§ 371 Date: Aug. 18, 2021

(30) Foreign Application Priority Data
Sep. 12, 2019 (JP) 2019-165867

(51) Int. Cl. H04L 41/22; H04L 43/0876

(52) U.S. Cl. CPC H04L 41/22; H04L 43/0876

(57) ABSTRACT

An information processing apparatus includes a display controller. The display controller controls a display of a flow by displaying, on a topology of a network, a symbol indicating data that flows in the network, the flow being the flowing of the data in the network. The display controller changes a display mode for the symbol for each type of the data.

### TECHNICAL FIELD

The present technology relates to an information processing apparatus, an information processing method, and a program, and in particular, to an information processing apparatus, an information processing method, and a program that make it possible to know a state of a network.

### CROSS REFERENCE TO RELATED APPLICATIONS

This application claims the benefit of Japanese Priority Patent Application JP 2019-165867 filed Sep. 12, 2019, the entire contents of which are incorporated herein by reference.

### BACKGROUND ART

In related art, Audio-Visual over Internet Protocol (AV over IP) that IP-packetizes an AV signal including an image signal and a sound signal, and transmits the IP-packetized AV signal, has been widespread.

In the AV over IP, an AV signal is converted into an IP packet by an encoder, and each IP packet is transmitted using a device, such as an Ethernet cable or an IP switch, that is used to perform normal IP communications. A decoder reports, to a switch, an IP packet desired to be acquired using an internet group management protocol (IGMP), and decodes the IP packet acquired from the switch. Then, an image and sound are output using the decoded image signal and the decoded sound signal.

The AV over IP is different from a technology that uses a standard matrix switch in making it possible to transmit a large number of signals to a large number of des-tinations simultaneously. Further, the AV over IP makes it possible to transmit a signal over a long distance using a standard information technology (IT).

On the other hand, a plurality of signals is packetized, and the packetized plurality of signals is physically superimposed on a cable to be transmitted. Further, a path of each signal is determined according to the setting of a switch. Thus, it is difficult to know the path of each signal. Consequently, it is difficult to specify a cause of an anomaly and a countermeasure against it, compared to the case of transmitting a signal using a commonly used AV cable.

Therefore, a connection state of a port of, for example, a switch, and statistical information for each port have been used in the past in order to check if an AV signal is normally transmitted, the connection state being obtained using a simple network management protocol (SNMP), the statistical information being obtained using NetFlow/sFlow. However, such information is information for each port, and do not directly indicate each AV signal.

In this regard, it is possible to acquire information regarding flowing of data (a flow) in a network, for example, using software defined networking (SDN) such as OpenFlow. It is possible to analyze an anomaly in a network in more detail using the technologies described above.

Further, in related art, it has been proposed that a topology of a network be displayed and that flowing of data on the topology be represented by the movement of a symbol (for example, refer to Patent Literature 1).

### CITATION LIST

### Patent Literature

PTL 1: Japanese Patent Application Laid-open No. 2016-194752

### SUMMARY OF INVENTION

### Technical Problem

However, when an anomaly in a network is analyzed using SDN, there is a need to confirm states of a large number of switches and a large number of devices that are connected to the network, and this results in a necessary time becoming longer.

Further, Patent Literature 1 discloses that a symbol is only used to indicate a path and a direction for data to flow. Thus, for example, it is difficult to know the flow of data for each type of data.

The present technology has been made in view of the circumstances described above, and makes it possible to know a state of a network quickly and easily.

### Solution to Problem

An information processing apparatus according to an embodiment of the present technology includes a display controller that controls a display of a flow by displaying, on a topology of a network, a symbol indicating data that flows in the network, the flow being the flowing of the data in the network; and changes a display mode for the symbol for each type of the data.

An information processing method according to an embodiment of the present technology is performed by an information processing apparatus, and includes: controlling a display of a flow by displaying, on a topology of a network, a symbol indicating data that flows in the network, the flow being the flowing of the data in the network; and changing a display mode for the symbol for each type of the data.

A program according to an embodiment of the present technology causes a computer to perform a process including: controlling a display of a flow by displaying, on a topology of a network, a symbol indicating data that flows in the network, the flow being the flowing of the data in the network; and changing a display mode for the symbol for each type of the data.

### Advantageous Effects of Invention

According to an embodiment of the present technology, a display of a flow is controlled by a symbol indicating data that flows in a network being displayed on a topology of the network, the flow being the flowing of the data in the network; and a display mode for the symbol is changed for each type of the data.

### BRIEF DESCRIPTION OF DRAWINGS

FIG. 1 is a block diagram of an example of a configuration of a communication system that uses the present technology.

FIG. 2 is a flowchart illustrating processing in a server.

FIG. 3 is a flowchart illustrating processing in a client.

FIG. 4 illustrates a first example of a GUI.

FIG. 5 illustrates an example of a topology display of an entire network.

FIG. 6 illustrates an example of the topology display focused on a portion of the network.

FIG. 7 illustrates an example of the topology display focused on a portion of a flow.

FIG. 8 illustrates a modification of a layout of the topology display.

FIG. 9 illustrates an example of information displayed in a switch field of a status display section.

FIG. 10 illustrates an example of information displayed in an IGMP group field of the status display section.

FIG. 11 illustrates an example of information displayed in a device field of the status display section.

FIG. 12 illustrates an example of displaying a playback controller.

FIG. 13 illustrates a second example of the GUI.

FIG. 14 illustrates a third example of the GUI.

FIG. 15 illustrates an example of displaying a data symbol corresponding to data on which network address translation has been performed.

FIG. 16 is a flowchart illustrating a first embodiment of processing of reporting an anomaly.

FIG. 17 illustrates an example of an alert display when an unknown device has been detected.

FIG. 18 illustrates an example of the alert display when a bandwidth overflow has occurred.

FIG. 19 is a flowchart illustrating a second embodiment of the processing of reporting an anomaly.

FIG. 20 illustrates an example of an error notification.

FIG. 21 is a flowchart illustrating a third embodiment of the processing of reporting an anomaly.

FIG. 22 is a flowchart illustrating a fourth embodiment of the processing of reporting an anomaly.

FIG. 23 illustrates a modification of the topology display.

FIG. 24 illustrates a modification of the topology display.

FIG. 25 illustrates an example of a configuration of a computer.

### DESCRIPTION OF EMBODIMENTS

Embodiments of present technology will now be described. The descriptions are provided in the following order.

1. Embodiments

2. Modifications

3. Others

### 1. Embodiments

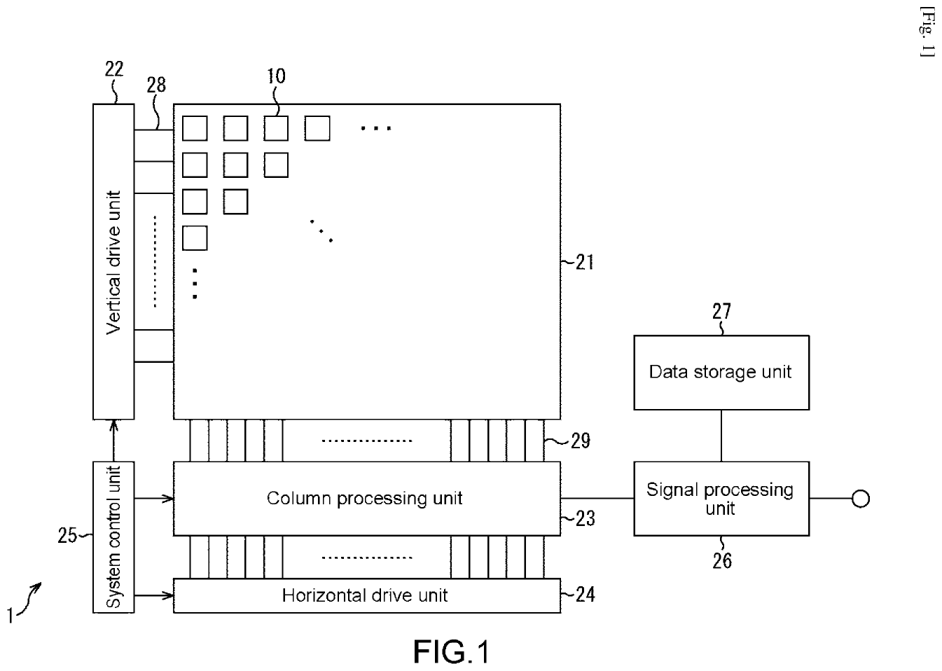

Embodiments of the present technology are described with reference to FIGS. 1 to 22.

### Example of Configuration of Communication System 1

FIG. 1 is a block diagram of an embodiment of a communication system 1 that uses the present technology.

The communication system 1 is a system that performs a transmission of an AV signal between a plurality of devices using the AV over IP. The communication system 1 includes transmission devices (TX) 11T-1 to 11T-m, reception devices (RX) 11R-1 to 11R-n, a switch group 12, a server 13, and a client 14. The transmission devices (TX) 11T-1 to 11T-m, the reception devices (RX) 11R-1 to 11R-n, the server 13, and the client 14 are connected to one another through the switch group 12.

In the following descriptions, the transmission devices (TX) 11T-1 to 11T-m simply refer to a transmission device 11T when there is no need to distinguish among the transmission devices (TX) 11T-1 to 11T-m. Further, the reception devices (RX) 11R-1 to 11R-n simply refer to a reception device 11R when there is no need to distinguish among the reception devices (RX) 11R-1 to 11R-n. Furthermore, the transmission device 11T and the reception device 11R simply refer to a device 11 when there is no need to distinguish between the transmission device 11T and the reception device 11R.

A device (not illustrated) such as a camera is connected to the transmission device 11T. A plurality of devices may be connected to the transmission device 11T.

The transmission device 11T receives an AV signal from a device connected to the transmission device 11T, separates a video signal, a sound signal, and a control signal that are included in the AV signal, and converts each of the signals into an IP packet to transmit them. In other words, the transmission device 11T generates an IP packet of a video signal, an IP packet of a sound signal, and an IP packet of a control signal, and adds address information to the IP packets to transmit them.

The address information includes a transmission-source address and a transmission-destination address. An address of a device of a transmission source of an AV signal is set to be the transmission-source address. A multicast IP address is set to be the transmission-destination address.

For example, the multicast IP address set to be the transmission-destination address may differ depending on a device of a transmission source of an AV signal, or may differ depending on a device of a transmission source of an AV signal and depending on the type of signal, or may be shared among devices connected to the transmission device 11T.

When a multicast IP address differs depending on a device, it is possible to identify a device of a transmission source a signal included in an IP packet using a transmission-destination address. When a multicast IP address differs depending on a device and the type of signal, it is possible to identify a device of a transmission source of a signal included in an IP packet, and the type of the signal included in the IP packet. When a multicast IP address is shared among devices, it is possible to identify a device of a transmission source of a signal included in an IP packet using a transmission-source address.

A device (not illustrated) such as a display device is connected to the reception device 11R. A plurality of devices may be connected to the reception device 11R.

The reception device 11R receives, from the switch group 12, an IP packet transmitted from the transmission device 11T in accordance with a request made by a device connected to the reception device 11R. Then, the reception device 11R transmits the received IP packet to the device that made the request.

The switch group 12 includes, for example, a spine switch and a leaf switch that deal with OpenFlow. Any number of switches included in the switch group 12 and any configuration of a connection between switches included in the switch group 12 are ac-ceptable.

Then, the respective devices 11 and the switch group 12 form a network 21 that deals with software-defined networking (SDN).

The server 13 collects information regarding the network 21 and analyzes a state of the network 21. The server 13 includes a data acquisition section 31, a model building section 32, an analyzer 33, a data accumulator 34, and a communication section 35.

From the respective devices 11 and (respective switches included in) the switch group 12, the data acquisition section 31 acquires pieces of status information respectively indicating their states through the communication section 35. Further, the data acquisition section 31 accumulates, in the data accumulator 34, the pieces of status information acquired from the respective devices 11 and the switch group 12.

The model building section 32 integrates the pieces of status information regarding the respective devices 11 and the switch group 12, and models the integrated pieces of status information, so as to build a model indicating a state of the network 21 (hereinafter referred to as a network model). The model building section 32 transmits information indicating the built network model (hereinafter referred to as network model information) to the client 14 through the communication section 35 and the switch group 12, and accumulates the built network model in the data accumulator 34.

The analyzer 33 compares the built network model with design information regarding the network 21 or with a previous network model, so as to analyze a state of the network 21. The design information regarding the network 21 includes, for example, the number of devices and the number of switches, names of the type of device and the type of switch, and maximum bit rates of pieces of data flowing to respective interfaces of devices and switches. Further, the analyzer 33 transmits information indicating a result of analyzing the state of the network 21 (hereinafter referred to as network analysis information) to the client 14 through the communication section 35 and the switch group 12.

The data accumulator 34 accumulates therein pieces of previous status information regarding the respective devices 11 and the switch group 12, and previous network model information. Further, the data accumulator 34 accumulates therein the design information regarding the network 21.

The communication section 35 communicates with the switch group 12. Further, the communication section 35 communicates with the respective devices 11 and the client 14 through the switch group 12.

The client 14 is used to, for example, monitor the network 21. The client 14 includes an input section 41, a display controller 42, a display section 43, and a communication section 44.

The input section 41 includes, for example, various input devices, and is used to input, for example, various data and various instructions. The types of and the number of input devices included in the input section 41 are not particularly limited, and, for example, a touch panel, a keyboard, a mouse, a button, or a switch is used as necessary.

The display controller 42 controls a display of various information that is performed by the display section 43. For example, the display controller 42 controls a display of a state of the network 21 using the network model information and the network analysis information that are acquired from the server 13. The state of the network 21 is represented by, for example, a topology of the network 21, statuses of the respective devices 11 and the switch group 12, and flowing of data (a flow) in the network 21.

The display section 43 includes a display device such as a display.

The communication section 44 communicates with the switch group 12. Further, the communication section 44 communicates with the respective devices 11 and the server 13 through the switch group 12.

<Processing in Server 13>

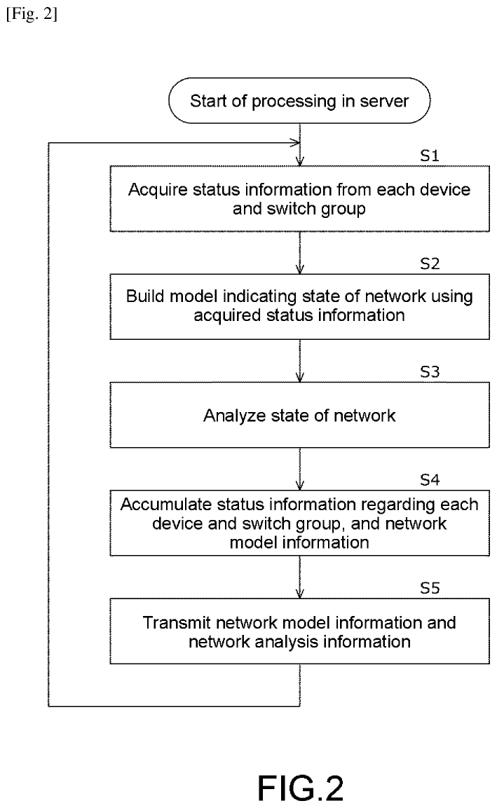

Next, processing performed in the server 13 is described with reference to a flowchart of FIG. 2.

For example, this processing is started when the server 13 is powered on, and is terminated when the server 13 is powered off.

In Step S1, the data acquisition section 31 acquires pieces of status information from the respective devices 11 and the switch group 12. Specifically, the data acquisition section 31 acquires pieces of status information from the respective devices 11 and (respective switches included in) the switch group 12 through the communication section 35.

In Step S2, the model building section 32 builds a model indicating a state of the network 21 using the acquired pieces of status information. Specifically, the model building section 32 integrates the pieces of status information regarding the respective devices 11 and the switch group 12, and performs modeling, so as to build a network model. The network model is represented by, for example, a wiring state and a connection state of the respective devices 11 and the switch group 12, and a transmission state of data (an IP packet) in the network 21.

In Step S3, the analyzer 33 analyzes the state of the network 21. For example, the analyzer 33 compares the built network model with design information regarding the network 21 that is accumulated in the data accumulator 34, and obtains a difference between a current state of the network 21 and a normal state of the network 21, so as to analyze the state of the network 21. Further, for example, the analyzer 33 compares the built network model with a previous network model that is accumulated in the data accumulator 34, and obtains a difference between a current state of the network 21 and a previous state of the network 21, so as to analyze the state of the network 21.

In Step S4, the server 13 accumulates therein pieces of status information regarding the respective devices 11 and the switch group 12, and network model information. Specifically, the data acquisition section 31 accumulates, in the data accumulator 34, the pieces of status information that are acquired from the respective devices 11 and the switch group 12. Further, the model building section 32 accumulates network model information indicating the built network model.

In Step S5, the server 13 transmits network model information and network analysis information. Specifically, the communication section 35 transmits, to the client 14 and through the switch group 12, the network model information generated by the model building section 32 and the network analysis information generated by the analyzer 33.

After that, the process returns to Step S1, and the processes of and after Step S1 are performed.

<Processing in Client 14>

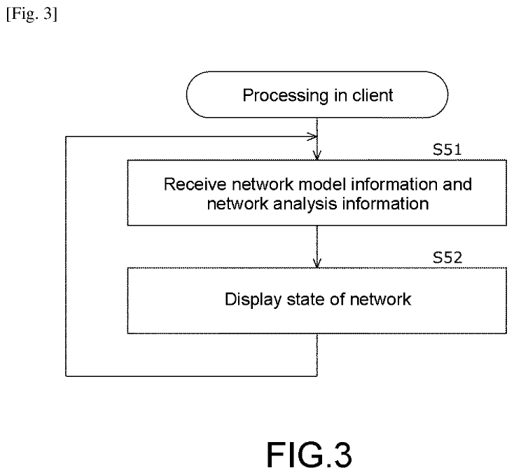

Next, processing performed in the client 14 in response to the processing in the server 13 illustrated in FIG. 2, is described with reference to a flowchart of FIG. 3.

For example, this processing is started when the client 14 is powered on, and is terminated when the client 14 is powered off.

In Step S51, the communication section 35 receives, through the switch group 12, the network model information and the network analysis information that are transmitted from the server 13 in the process of Step S5 of FIG. 2.

In Step S52, the client 14 displays a state of the network 21. Specifically, the display controller 42 displays a GUI indicating the state of the network 21 on the display section 43 according to the network model information and the network analysis information.

After that, the process returns to Step S51, and the processes of Steps S51 and S52 are repeatedly performed.

### <Example of GUI Indicating State of Network 21>

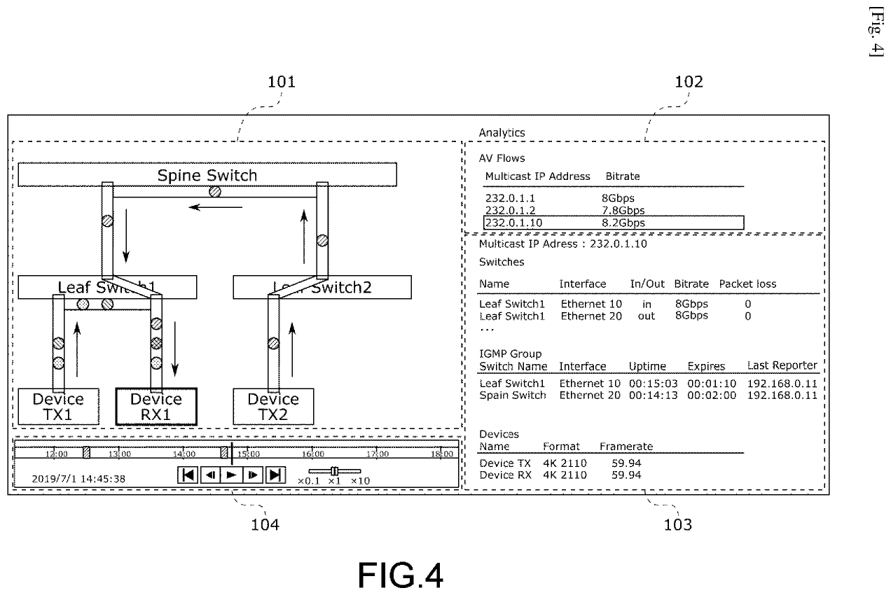

Next, an example of a GUI displayed by the client 14 in the process of Step S52 of FIG. 3, is described with reference to FIGS. 4 to 15.

### <First Example of GUI>

FIG. 4 illustrates a first example of a GUI.

This GUI includes a network display section 101, a flow display section 102, a status display section 103, and a playback controller 104. The network display section 101 and the playback controller 104 are arranged one above the other on the left of the GUI, and the flow display section 102 and the status display section 103 are arranged one above the other on the right of the GUI.

A topology that indicates a wiring state of the devices 11 and the switch group 12 in the network 21 is displayed on the network display section 101.

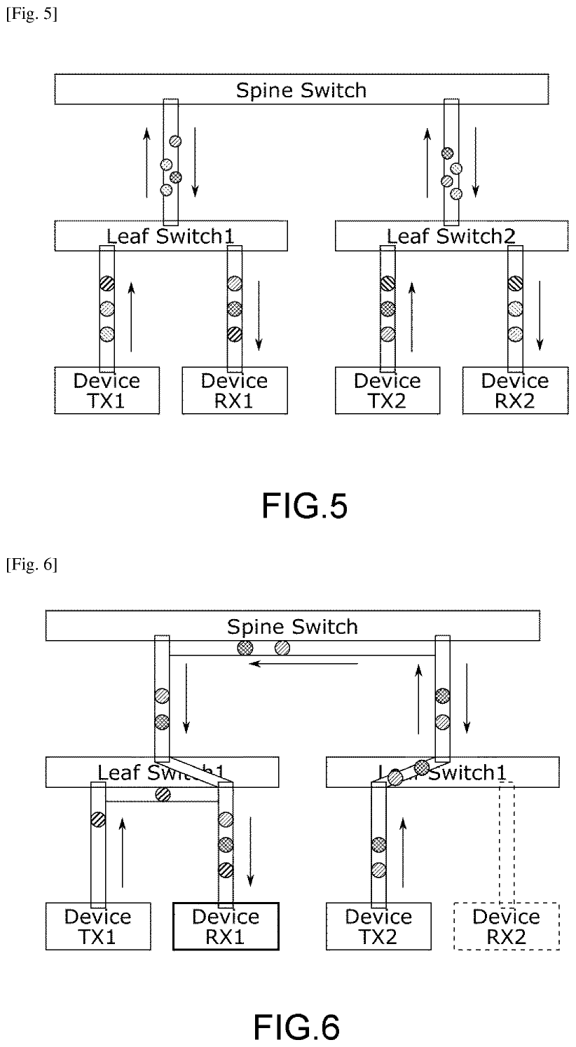

Here, an example of a topology display on the network display section 101 is described with reference to FIGS. 5 to 9.

### Example of Display of Entire Network

FIG. 5 illustrates an example of displaying an entire configuration of the network 21.

In this example, a leaf switch 1 and a leaf switch 2 are connected to a spine switch. A transmission device TX1 and a reception device RX1 are connected to the leaf switch 1. A transmission device TX2 and a reception device RX2 are connected to the leaf switch 2.

Rectangular shapes each indicating an interface (such as a port) are respectively displayed on the respective switches and the respective devices. Further, a line indicating a transmission path between a switch and a device connects their interfaces.

A circular symbol (hereinafter referred to as a data symbol) representing data (an IP packet group) is displayed on each line, and moves in a direction in which data flows. This movement of a data symbol and an arrow indicate a flow (flowing of data) in the network 21.

Further, a display mode for a data symbol differs depending on the type of data. For example, the data symbol differs depending on the type of data, by use of, for example, color, a pattern in the data symbol, a letter and a mark in the data symbol, the size, and the shape. Note that, in this example, a pattern in a data symbol is changed for each type of data.

For example, the type of data is classified by address information regarding each data. Thus, pieces of data having an identical piece of address information are represented, as an identical type of data, by a data symbol in an identical display mode. Pieces of data having different pieces of address information are respectively represented, as different types of data, by data symbols in different display modes.

Note that, as described above, the address information includes a transmission-source address and a transmission-destination address. Further, the type of data is classified by at least one of the transmission-destination address or the transmission-source address. In other words, the type of data may be classified only by the transmission-destination address, or only by the transmission-source address, or by a combination of the transmission-destination address and the transmission-source address.

Further, there is a difference in a display mode for a data symbol between a transmission path through which data only flows in one direction and a transmission path through which data flows in both directions.

For example, data only flows, in one direction, through a transmission path between the leaf switch 1 and the transmission device TX1, through a transmission path between the leaf switch 1 and the reception device RX1, through a transmission path between the leaf switch 2 and the transmission device TX2, and through a transmission path between the leaf switch 2 and the reception device RX2. Thus, with respect to these transmission paths, a data symbol is displayed such that the size of the data symbol fits the width of a line.

On the other hand, data flows, in both directions, through a transmission path between the spine switch and the leaf switch 1 and through a transmission path between the spine switch and the leaf switch 2. Thus, with respect to these transmission paths, the size of a data symbol is smaller than the width of a line. Further, a data symbol is displayed on the right or on the left in a line depending on the direction in which data flows. In other words, respective data symbols are displayed to move on the left in a line.

Such a topology display enables a user to easily understand the configuration of the network 21. Further, the user can easily know a path of data flowing in the network 21 for each type of data.

### Example of Display Focused on Portion of Network

FIG. 6 illustrates an example of a topology display focused on a portion of the network 21. In this case, only flowing of data that passes through a portion to be focused on, that is, only a flow that passes through a portion to be focused on is displayed on a topology. In other words, a partial topology that is a topology corresponding to a portion of a network is displayed.

Note that an interface of an entire switch or a portion of the switch, and an interface of an entire device or a portion of the device are examples of the portion on which it is possible to be focused.

Further, a method for specifying a portion to be focused on is not particularly limited. For example, a user specifies or selects a desired device, switch, or interface on a topology display or on the status display section 103 described later, so as to specify a portion to be focused on. Then, a topology display is performed that is related to the portion that has been focused on.

In this example, an example of performing display focused on the entire reception device RX1 is described.

Specifically, only a flow passing through the reception device RX1 from among flows in the network 21 is highlighted to be displayed, and the other flows are not displayed.

Further, the path of data is also displayed in a switch. For example, a line that connects interfaces through which data passes, is displayed in each of the spine switch, the leaf switch 1, and the leaf switch 2.

Note that, for example, each line is displayed in a display mode that is different from a display mode in which the entire network 21 is displayed.

Further, a switch, a device, and a transmission path that are unrelated to the flow passing through the reception device RX1, are not displayed, and thus, the number of switches displayed, the number of devices displayed, and the number of transmission paths displayed are reduced. In this example, the reception device RX2, and the line between the reception device RX2 and the leaf switch 1 that are indicated by dotted lines are not displayed.

This enables a user to easily know a state of a flow passing through a switch, a device, or an interface to be focused on.

Note that it is desirable that a non-displayed portion be automatically redisplayed, for example, when an anomaly has occurred in the non-displayed portion. It is desirable that the reception device RX2 and the line between the reception device RX2 and the leaf switch 2 be automatically redisplayed, for example, when an anomaly has occurred in the reception device RX2.

### Example of Display Focused on Portion of Flow

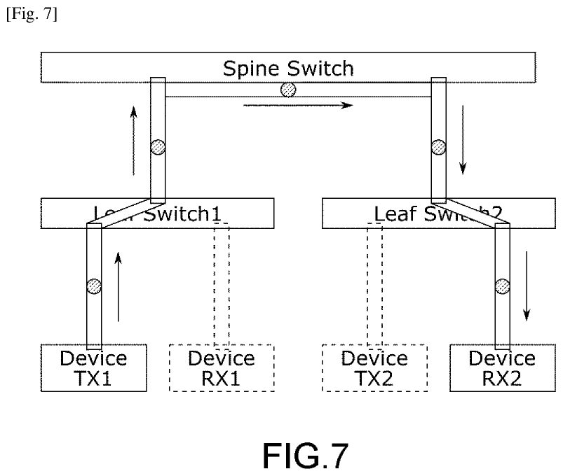

FIG. 7 illustrates an example of the topology display focused on a specific flow in the network 21. In this case, only a flow that has been focused on is displayed by a method similar to the method applied to the example of FIG. 6.

Note that a method for specifying a flow to be focused on is not particularly limited. For example, a user indicates a data symbol on a topology display or selects a desired flow in the flow display section 102 described later, so as to specify a flow to be focused on. Then, a topology is displayed that is related to the flow that has been focused on.

In this example, an example focused on one of the flows from the transmission device TX1 to the reception device RX2, is described.

Specifically, only a flow to be focused on is highlighted to be displayed, and the other flows are not displayed. In other words, a data symbol and a line that are related to a flow to be focused on are highlighted to be displayed.

Further, a path of data is also displayed in a switch. For example, a line that connects interfaces through which data passes, is displayed in each of the spine switch, the leaf switch 1, and the leaf switch 2.

Note that, for example, each line is displayed in a display mode that is different from a display mode in which the entire network 21 is displayed.

Further, a switch, a device, and a transmission path that are unrelated to the flow to be focused on, are not displayed, and thus, the number of switches displayed, the number of devices displayed, and the number of transmission paths displayed are reduced. In this example, the reception device RX1, the line between the reception device RX1 and the leaf switch 1, the transmission device TX2, and the line between the transmission device TX2 and the leaf switch 2 that are indicated by dotted lines are not displayed.

Furthermore, even when there exists another flow that passes through a path identical to the path of a flow to be focused on, a data symbol corresponding to the other flow is not displayed.

This enables a user to easily know a state of a flow to be focused on.

Note that it is possible to select a flow to be focused on for each piece of address information regarding data (for example, for each multicast IP address). Further, for example, the flow to be focused on may be selected for each content of data (such as a video signal, a sound signal, or a control signal).

Note that it is desirable that a non-displayed portion be automatically redisplayed when an anomaly has occurred in the non-displayed portion, as in the example of FIG. 6 described above.

<Modification of Layout of Topology Display>

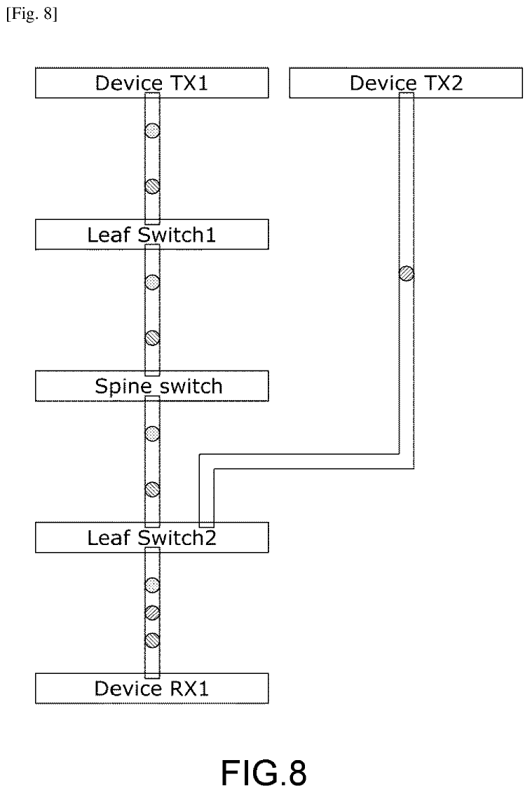

FIG. 8 illustrates a modification of a layout of the topology display.

In this example, paths situated between the transmission device and the reception device are arranged in a certain direction (in this case, in an up-and-down direction). In other words, switches through which data passes between the transmission device and the reception device are vertically aligned to be displayed. This enables a user to easily confirm the path of a flow.

For example, a topology display of an entire network may normally be performed in the layout of FIG. 4, and a topology display may be performed in the layout of FIG. 8 when focusing on a portion of a network or a flow.

Returning to FIG. 4, a list of information related to a flow in the entire network 21 is displayed on the flow display section 102. For example, a multicast IP address and a bit rate of a transmission destination of data transmitted through each flow, are displayed.

The user can select a desired flow from among flows listed to be displayed on the flow display section 102. Then, statuses of a device and a switch that are related to the flow selected on the flow display section 102, are displayed on the status display section 103.

The status display section 103 includes a switch field, an Internet Group Management Protocol (IGMP) group field, and a device field.

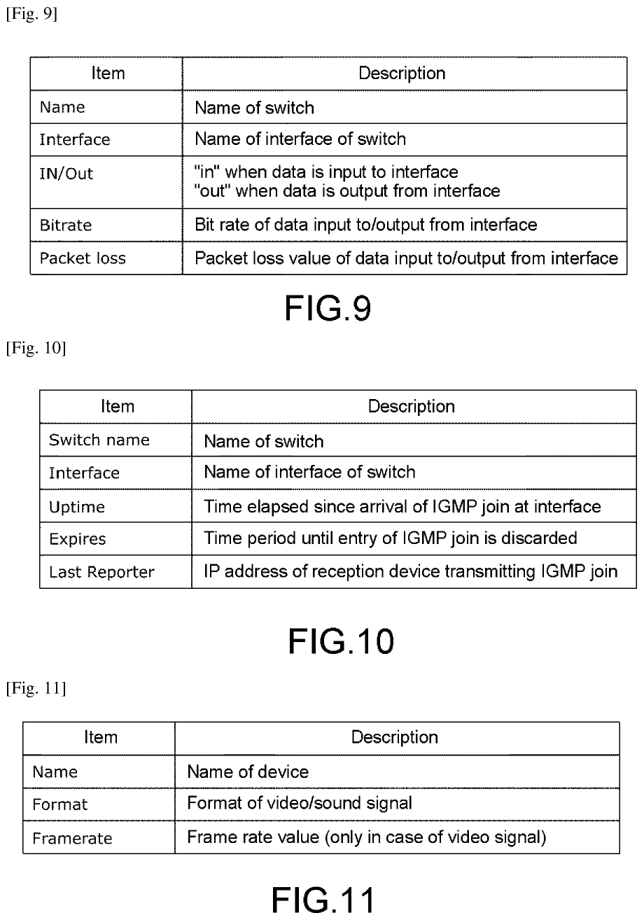

FIG. 9 illustrates an example of information displayed in the switch field. The switch field includes information regarding a switch and an interface through which the flow selected on the flow display section 102 passes. The switch field includes items of Name, Interface, In/Out, Bitrate, and Packet loss.

Name represents a name of a switch.

Interface represents a name of an interface of a switch.

In/Out represents flowing of data to an interface of a switch. When data is input to an interface, “in” is displayed, and when data is output from an interface, “out” is displayed.

Bitrate represents a bit rate of data input to an interface or output from the interface.

Packet loss represents a packet loss value of data input to an interface or output from the interface.

FIG. 10 illustrates an example of information displayed in the IGMP group field. The IGMP group field includes information regarding an IGMP group which a device receiving the flow selected on the flow display section 102 belongs to. The IGMP group field includes items of Switch Name, Interface, Uptime, Expires, and Last Reporter.

Switch Name represents a name of a switch.

Interface represents an interface of a switch.

Uptime represents a time elapsed since IGMP Join arrived at an interface.

Expires represents a time period until an entry of IGMP Join is discarded.

Last Reporter represents an IP address of a reception device transmitting IGMP Join.

FIG. 11 illustrates an example of information displayed in the device field. The device field includes information regarding devices of a transmission source and a transmission destination of the flow selected on the flow display section 102. The device field includes items of Name, Format, and Framerate.

Name represents a name of a device.

Format represents a format of a video signal when a flow of the video signal is selected, or a format of a sound signal when a flow of the sound signal is selected.

Framerate represents a frame rate value of a video signal when a flow of the video signal is selected.

Returning to FIG. 4, the playback controller 104 is a portion with which a user performs an operation regarding, for example, a position of playing back a state of the network 21.

Specifically, in addition to being provided with a live mode in which a current state of the network 21 is displayed, the client 14 is provided with a record playback mode in which a previous state of the network 21 is displayed (played back). Then, primarily in the record playback mode, the user performs an operation of, for example, specifying a position of playing back a state of the network 21, using the playback controller 104.

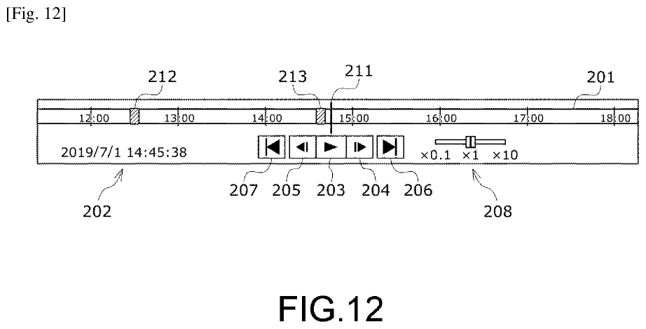

As illustrated in FIG. 12, the playback controller 104 includes a slider 201, a date-and-time field 202, a playback button 203, a frame advance button 204, a frame reverse button 205, a forward-direction skip button 206, a backward-direction skip button 207, and a slider 208.

A scale indicating a time axis and a cursor 211 are displayed on the slider 201. A time pointed by the cursor 211 indicates a current playback position (a date and time at which a currently displayed state of the network 21 occurred). Further, as the playback of a state of the network 21 proceeds, the scale of the slider 201 is shifted to the left with the position of the cursor 211 being fixed. Furthermore, the user can specify the playback position by moving the scale of the slider 201. Moreover, a box 212 and a box 213 that each indicate a date and time at which a communication anomaly has occurred, are displayed on the slider 201.

The date-and-time field 202 indicates a date and time of a current playback position. The user can specify the playback position by directly inputting a desired date and time to the date-and-time field 202.

When the playback button 203 is pressed down, a state of the network 21 starts being played back, and the playback button 203 is changed to a pause button (not illustrated). When the pause button is pressed down, the playback of the state of the network 21 is stopped, and the pause button is changed to the playback button 203.

When the frame advance button 204 is pressed down, the playback position goes forward by a specified time. When the frame reverse button 205 is pressed down, the playback position goes backward by a specified time.

When the forward-direction skip button 206 is pressed down, the playback position goes forward up to a position corresponding to a date and time at which an anomaly occurred, the position being situated posterior to and closest to the current playback position. When the backward-direction skip button 207 is pressed down, the playback position goes backward up to a position corresponding to a date and time at which an anomaly occurred, the position being situated prior to and closest to the current playback position.

The slider 208 is used to set the playback speed of a state of the network 21. When the slider 208 is set in the middle, the playback speed is set to be one time. The playback speed is faster if the slider 208 is set further to the right, and the playback speed is slower if the slider 208 is set further to the left.

As described above, a user can easily know a state of the network 21 using the GUI of FIG. 4. Further, the user can easily confirm states of a desired device, a desired switch, a desired interface, and a desired flow. Furthermore, the user can easily know a previous state of the network 21.

Moreover, when a communication anomaly has occurred in the network 21, a user can quickly specify a portion in which the anomaly has occurred and a cause of the anomaly, and take countermeasures against it.

For example, in the AV over IP, the following troubles are expected to occur due to communication anomaly.
An image and sound are not output.
An image and sound are not switched.
Disturbance occurs in an image and sound.
Delay in an image and sound is caused.

For example, the following points are confirmed on site when the above troubles occur.
A bandwidth overflow, a packet loss, and a packet delay between ports of respective switches
A bandwidth overflow, a packet loss, and a packet delay between switches
A bandwidth overflow, a packet loss, and a packet delay between a switch and a device
Formats of a video signal and a sound signal that are transmitted by a transmission device
Formats of a video signal and a sound signal that are received by a reception device
Monitoring of an IGMP table
Whether a flow passes through a port of a switch through which the flow is not supposed to pass

For example, the GUI described above makes it possible to easily confirm the above points to be confirmed, and this results in being able to quickly specify a portion in which an anomaly has occurred and a cause of the anomaly, and take countermeasures against it.

### <Second Example of GUI>

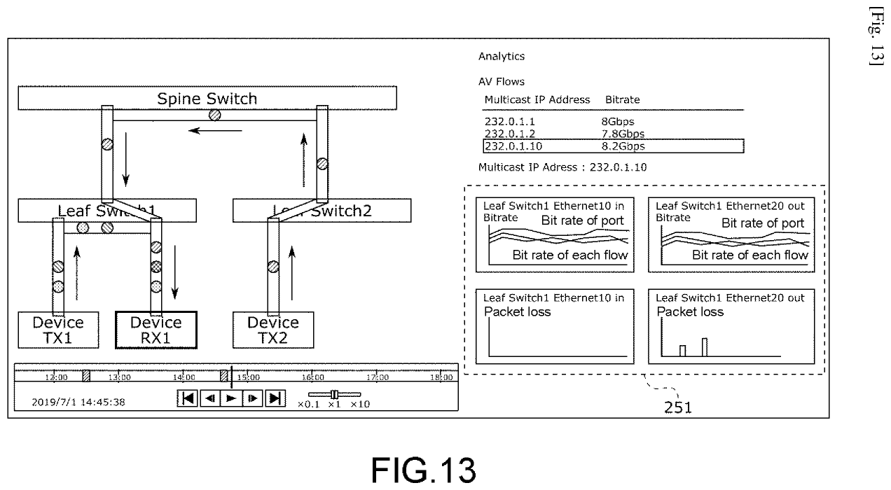

FIG. 13 illustrates a second example of the GUI.

The GUI of FIG. 13 is different from the GUI of FIG. 4 in including a status display section 251 instead of the status display section 103.

In this example, a transition of a status of each switch is displayed using a graph.

Specifically, graphs are displayed that indicate time-series transitions of a bit rate and a packet loss of an interface (a port) of the leaf switch 1, the interface (the port) being an interface (a port) to which data is input in a flow selected on the flow display section 102. Further, graphs are displayed that indicate time-series transitions of a bit rate and a packet loss of an interface (a port) of the leaf switch 1, the interface (the port) being an interface (a port) from which data is output in the flow selected on the flow display section 102.

This makes it possible to easily understand a time-series change in a status of the leaf switch 1.

Note that a transition of a status of each device may be displayed using a graph.

### <Third Example of GUI>

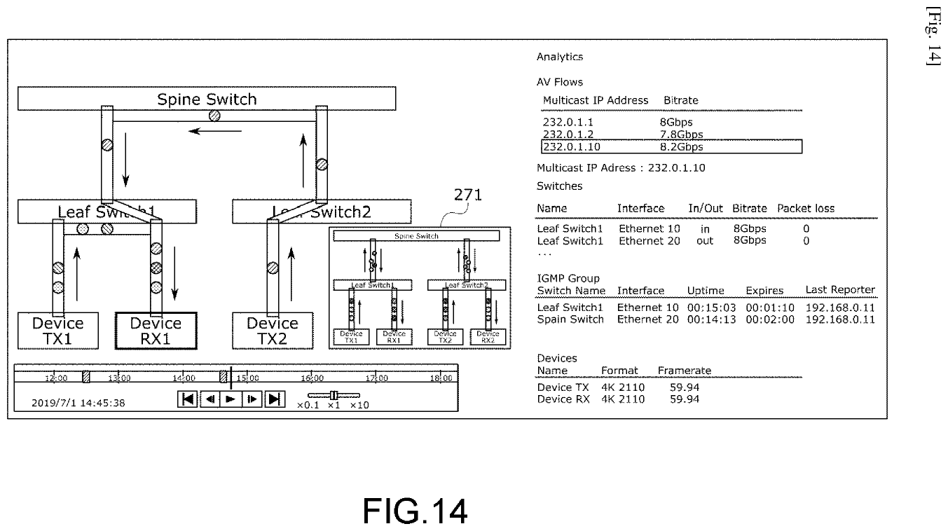

FIG. 14 illustrates a third example of the GUI.

The GUI of FIG. 14 is different from the GUI of FIG. 4 in that a network display section 271 is added.

In other words, in this example, topologies in two different types of display modes are displayed.

Accordingly, for example, it is possible to simultaneously display the topology of an entire network described above with reference to FIG. 4, and the topology focused on a portion of a network or a portion of a flow described above with reference to FIGS. 6 to 8.

Further, for example, it is possible to display the topology focused on a portion of a network or a portion of a flow in different layouts (the layout of FIG. 6 or FIG. 7, and the layout of FIG. 8) simultaneously.

<Modification of Display Mode of Data Symbol>

Next, a modification of a display mode for a data symbol in a topology display is described.

For example, it becomes more difficult to identify the type of data using a display mode as the number of types of data is increased. In this regard, for example, a display mode for a data symbol may be unified when the number of types of data in the entire network 21 is not less than a specified threshold. In other words, data symbols respectively corresponding to all of the types of data may be displayed in an identical display mode.

Further, a user may select, according to the number of types of data, whether to dif-ferentiate among display modes for data symbols or to unify the display modes for data symbols.

Furthermore, for example, for each of the methods for displaying a topology described above with reference to FIGS. 5 to 8, switching may be performed between differentiating among display modes for data symbols and unifying the display modes for data symbols. For example, the display modes for data symbols may be unified when a topology of an entire network is displayed, and differentiation may be performed among the display modes for data symbols when a topology focused on a portion of a network or a portion of a flow is displayed.

Further, for example, switching may be performed between differentiating among display modes for data symbols and unifying the display modes for data symbols according to the size or the display magnification of a topology display.

Furthermore, when there exists a large number of types of data transmitted and received by a device or a switch, the visibility may be reduced by displaying data symbols respectively corresponding to all of the pieces of data. In this regard, for example, the number of displayed data symbols transmitted and received by each device or each switch may be limited to the number not greater than a specified threshold.

Moreover, for example, the side or the length of a data symbol may be changed according to the level of a bit rate of corresponding data. For example, a data symbol may be made larger or longer as the bit rate of corresponding data is increased.

Further, for example, a display mode may be changed such that a data symbol is highlighted that corresponds to a flow in which an anomaly such as a bandwidth overflow or a packet loss has occurred. For example, a data symbol may be made red, or may be caused to blink.

Further, in the example of FIG. 5, there is a difference in a display mode for a data symbol between a transmission path through which data only flows in one direction and a transmission path through which data flows in both directions. In this regard, for example, the display mode for a data symbol for the transmission path through which data only flows in one direction, and the display mode for a data symbol for the transmission path through which data flows in both directions may be identical to each other. For example, also in the transmission path through which data only flows in one direction, a data symbol may be displayed to the left side or the right side of a line according to the direction in which data flows, as in the case of the transmission path through which data flows in both directions.

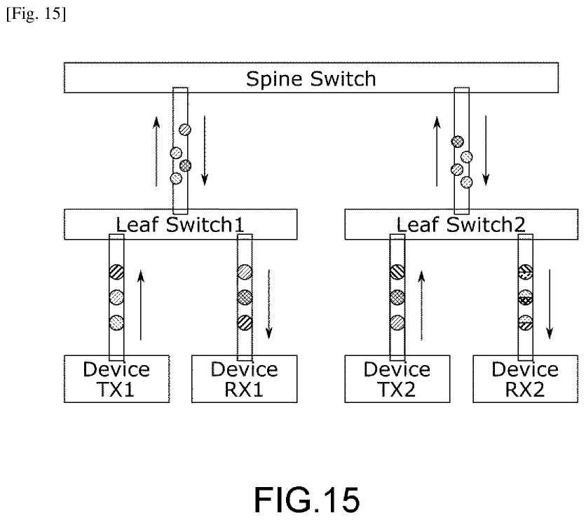

Furthermore, for example, as illustrated in FIG. 15, the display mode for a data symbol corresponding to data whose address information has been translated by performing, for example, network address translation (NAT) or port address translation (PAT), may be changed such that the data symbol can be identified.

FIG. 15 illustrates an example in which the address information of data received by the reception device RX2 is translated in the leaf switch 2. In the case of this example, there is a difference in display mode between an upper portion and a lower portion of a data symbol situated in a line between the leaf switch 2 and the reception device RX2. For example, the upper portion is in a display mode corresponding to the data before the address information is translated (for example, a normal color), and the lower portion is in a display mode corresponding to the data after the address information is translated (for example, a lighter color than the normal color).

Accordingly, even if address information of data is translated halfway, a user can recognize the data having the address information after the translation is data of a type identical to the type of data having the address information before the translation.

Note that, for example, different modes may be used for a line corresponding to a transmission path through which data before network address translation flows and for a line corresponding to a transmission path through which data after the network address translation flows. For example, the line corresponding to a transmission path through which data before network address translation flows may be displayed in a normal color, and the line corresponding to a transmission path through which data after the network address translation flows may be displayed in a lighter color than the normal color.

<Processing of Reporting Anomaly>

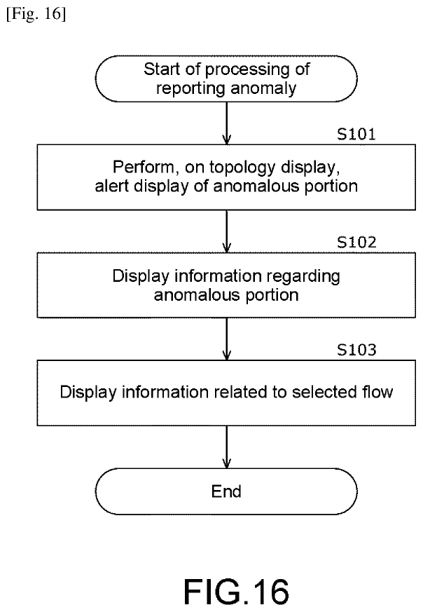

Next, processing of reporting an anomaly that is performed by the client 14 when a communication anomaly has occurred, is described with reference to FIGS. 16 to 22.

### First Embodiment of Processing of Reporting Anomaly

First, a first embodiment of the processing of reporting an anomaly that is performed in the client 14 is described with reference to a flowchart of FIG. 16.

In Step S101, the display section 43 performs, on a topology display, an alert display of an anomalous portion under the control of the display controller 42.

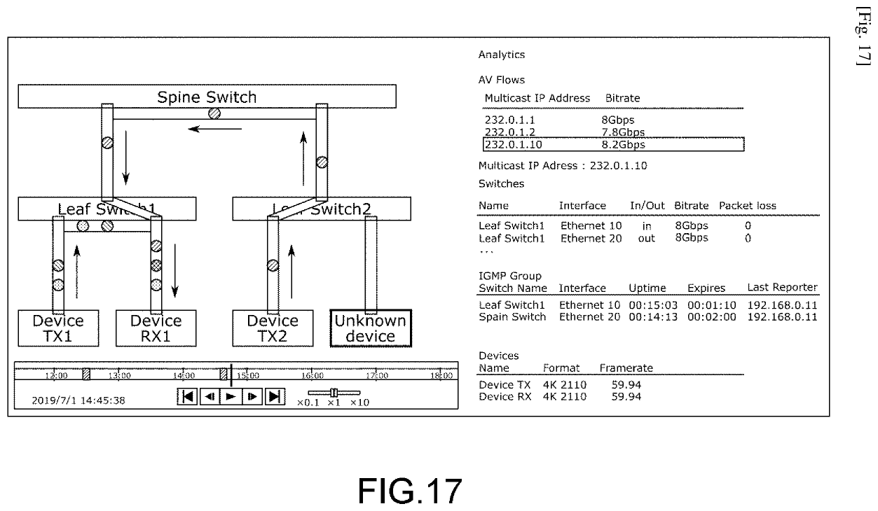

FIG. 17 illustrates an example of the alert display when an unknown device has been detected. In this example, an unknown device that is not included in design information but is connected to the leaf switch 2 is highlighted to be displayed in a display mode different from the display mode of the other devices.

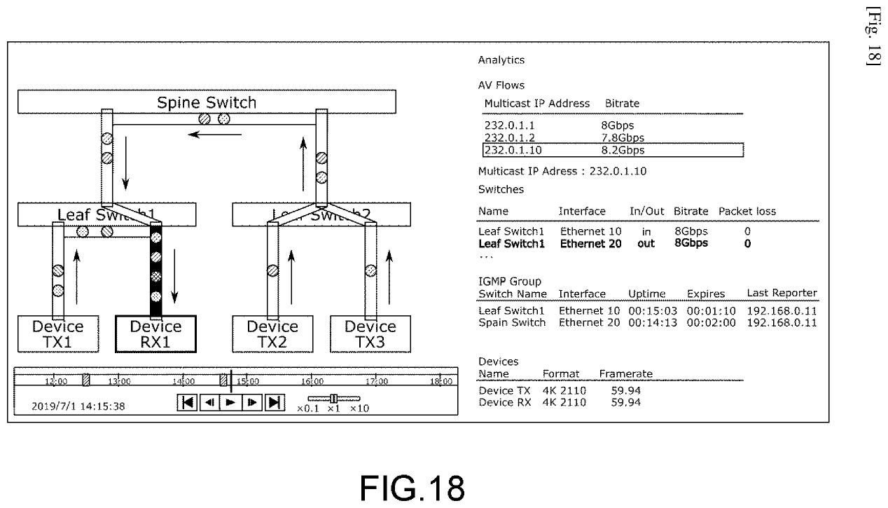

FIG. 18 illustrates an example of the alert display when a bandwidth overflow has occurred. For example, the alert display is performed when the maximum bandwidth is set for each set of transmission path and interfaces upon designing a system and when a transmission path and interfaces in which a maximum-bandwidth overflow has occurred, have been detected upon operation. In this example, a bandwidth overflow has occurred in a transmission path between the leaf switch 1 and the reception device RX1, and a line corresponding to this transmission path is highlighted to be displayed in a display mode (for example, displayed in red, or blinking) different from the display mode of the other devices.

In Step S102, the client 14 displays information regarding the anomalous portion.

For example, a user operates the input section 41 to select the anomalous portion (such as a switch, a device, an interface of the switch or the device, or a line) for which an alert display is performed on a topology display. Alternatively, the anomalous portion for which an alert display is performed on a topology display is automatically selected. In response to this, under the control of the display controller 42, the display section 43 displays, on the network display section 101 and the flow display section 102 described above with reference to FIG. 4, information regarding a flow that passes through the selected anomalous portion.

In Step S103, the client 14 displays information related to the selected flow.

For example, the user operates the input section 41 to select one of the flows displayed on the flow display section 102. In response to this, under the control of the display controller 42, the display section 43 displays, on the status display section 103 described above with reference to FIG. 4, statuses of a device and a switch that are related to the selected flow.

After that, the processing of reporting an anomaly is terminated.

This enables a user to quickly detect a communication anomaly, specify a portion in which the anomaly has occurred and a cause of the anomaly, and take countermeasures against it.

### Second Embodiment of Processing of Reporting Anomaly

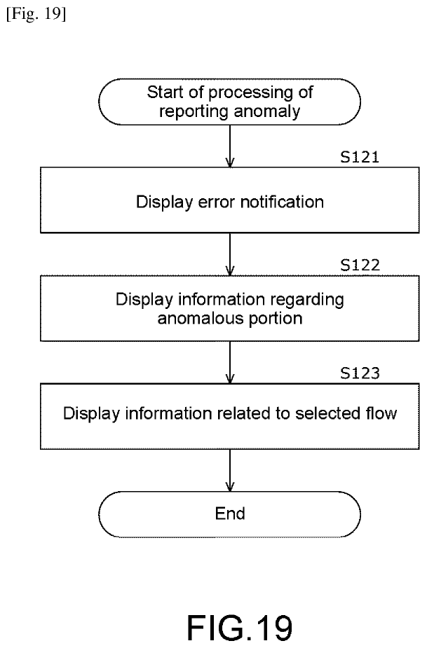

Next, a second embodiment of the processing of reporting an anomaly that is performed by the client 14 is described with reference to a flowchart of FIG. 19.

In Step S121, the display section 43 displays an error notification under the control of the display controller 42.

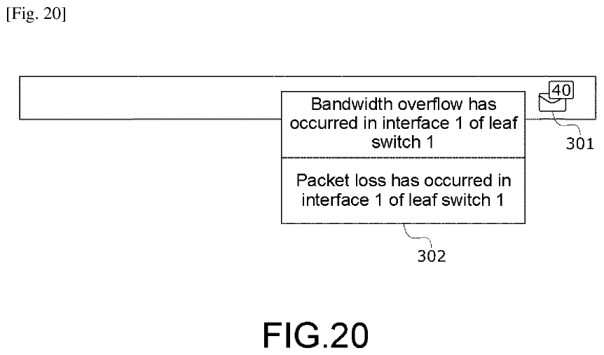

FIG. 20 illustrates an example of an error notification. For example, an icon 301 and a box 302 are displayed near an upper end and a right end of the GUI of FIG. 4.

The icon 301 is an icon indicating that there is an unconfirmed error notification, and includes the number of error notifications. In this example, the icon indicates that there are 40 unconfirmed error notifications.

Error information regarding an anomaly that has currently occurred is displayed in the box 302. In this example, the occurrence of a bandwidth overflow and a packet loss in the interface 1 of the leaf switch 1 is reported.

In Step S122, the client 14 displays information regarding an anomalous portion.

For example, the user operates the input section 41 to select the error notification by, for example, clicking. In response to this, under the control of the display controller 42, the display section 43 displays, on the network display section 101 and the flow display section 102 described above with reference to FIG. 4, information regarding a flow that passes through the anomalous portion indicated by the selected error notification.

In Step S123, information related to the selected flow is displayed, as in the case of the process of Step S103 of FIG. 16.

After that, the processing of reporting an anomaly is terminated.

This enables a user to quickly detect a communication anomaly, specify a portion in which the anomaly has occurred and a cause of the anomaly, and take countermeasures against it.

### Third Embodiment of Processing of Reporting Anomaly

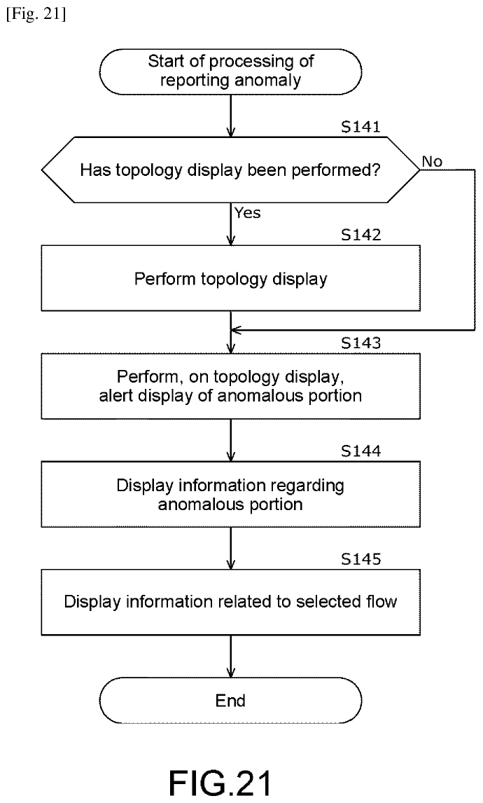

First, a third embodiment of the processing of reporting an anomaly that is performed by the client 14 is described with reference to a flowchart of FIG. 21.

In Step S141, the display controller 42 determines whether a topology display has been performed. For example, when the display controller 42 determines that a screen other than a GUI indicating a state of the entire network 21 is displayed on the display section 43 and a topology display has not been performed, the process moves on to Step S142.

In Step S142, the display section 43 performs a topology display under the control of the display controller 42. For example, the display section 43 performs a topology display by displaying the GUI indicating a state of the network 21 described above with reference to, for example, FIG. 4.

After that, the process moves on to Step S143.

On the other hand, when it is determined, in Step S141, that a topology display has been performed, the process of Step S142 is skipped, and the process moves on to Step S143.

In Steps S143 to S145, processes similar to the processes of Steps S101 to S103 of FIG. 16 are performed, and the processing of reporting an anomaly is terminated.

As described above, when a communication anomaly has occurred in a state in which a topology display has not been displayed, a topology display is automatically performed, and an alert display of an anomalous portion is performed. This enables a user to quickly detect a communication anomaly, specify a portion in which the anomaly has occurred and a cause of the anomaly, and take countermeasures against it.

### Fourth Embodiment of Processing of Reporting Anomaly

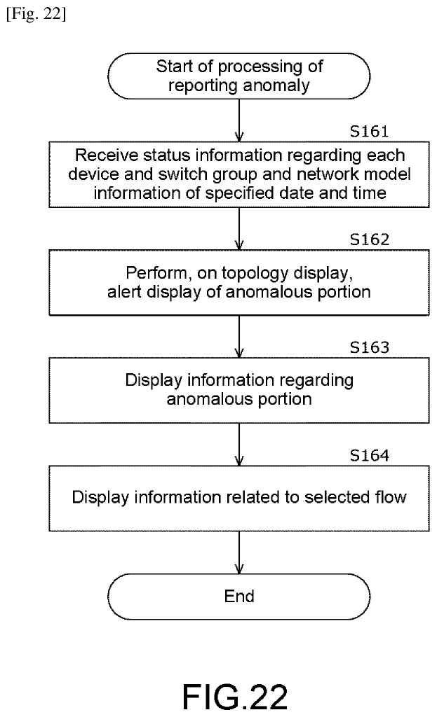

Next, a fourth embodiment of the processing of reporting an anomaly that is performed by the client 14 is described with reference to a flowchart of FIG. 22.

This processing is started, for example, when a user specifies a date and time at which an anomaly has occurred in the past, by operating the playback controller 104 of FIG. 13 described above.

In Step S161, the client 14 receives pieces of status information regarding the respective devices and the switch group and network model information of the specified date and time. Specifically, the display controller 42 transmits a signal to the server 13 through the communication section 44 and the switch group 12, the signal making a request that the server 13 transmit the pieces of status information regarding the respective devices and the switch group and the network model information of the specified date and time.

The data acquisition section 31 of the server 13 reads, from the data accumulator 34, the pieces of status information regarding the respective devices and the switch group and the network model information of the specified date and time, and transmits them to the client 14 through the communication section 35 and the switch group 12.

The display controller 42 of the client 14 receives the pieces of status information regarding the respective devices and the switch group and the network model information of the specified date and time that are transmitted by the server 13.

In Step S162, using the pieces of information acquired from the server 13, the display section 43 performs, on a topology display, an alert display of an anomalous portion under the control of the display controller 42, by performing a process similar to the process of Step S101.

In Steps S163 and S164, processes similar to the processes of Steps S102 and S103 of FIG. 16 are performed.

After that, the processing of reporting an anomaly is terminated.

This makes it possible to reproduce an anomaly that has occurred in the past, and to easily specify a portion in which an anomaly has occurred and a cause of the anomaly

### 2. Modifications

Modifications of the embodiments of the present technology described above are described below.

For example, information regarding a position (such as a switch, an interface, or a line) specified using, for example, a cursor may be displayed on the topology displays described above with reference to FIGS. 5 to 9.

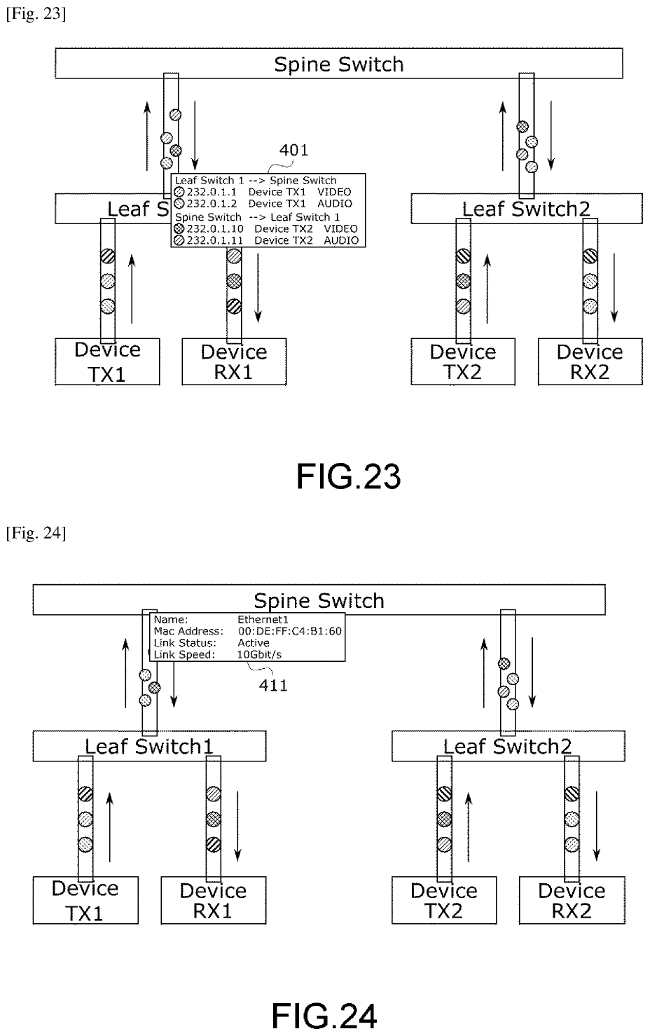

FIG. 23 illustrates an example in which the line between the spine switch and the leaf switch 1 is specified. In this example, a window 401 is displayed that indicates information regarding data that flows through the specified line.

Information regarding data that flows through the line, that is, information regarding data that flows from the leaf switch 1 to the spine switch and regarding data that flows from the spine switch to the leaf switch 1 is displayed in the window 401. The information regarding each piece of data includes a corresponding data symbol in a topology display, a multicast IP address, a name of a transmission device of a transmission source of the piece of data, and details of the piece of data.

FIG. 24 illustrates an example in which an interface of the spine switch is specified. In this example, a window 411 is displayed that indicates information regarding an interface.

A name of an interface, a MAC address of the interface, a link status, and a link speed indicating an available maximum bandwidth of the interface are displayed in the window 411.

“Active” is displayed for the link status when an interface is connected to another switch or device through a cable and is in a state of being able to communicate with the connection-destination switch or device. On the other hand, “Inactive” is displayed for the link status when the interface is not in a state of being able to communicate with the other switches or devices.

Further, the example of multicasting each piece of data has been described above, but the present technology is also applicable to the case of transmitting each piece of data by other methods such as unicast transmission.

Furthermore, for example, when an anomaly in the network 21 has been detected in a record playback mode, the record playback mode may be automatically switched to a live mode. In other words, when an anomaly in the network 21 has been detected in a state in which a previous state of the network is displayed in the record playback mode, a current state of the network may be displayed in the live mode.

Moreover, for example, when an anomaly in the network 21 has been detected, a topology display corresponding to a portion related to a portion in which the anomaly has occurred, may be automatically started. For example, a topology display focused on a switch, a device, or an interface in which an anomaly has occurred, or a topology display focused on a flow in which an anomaly has occurred may be automatically started.

Further, for example, portions that are not displayed in the topology displays of FIGS. 6 and 7 may be displayed to be faded so as to not be noticeable, or may be displayed using dotted lines.

### 3. Others

### Example of Configuration of Computer

The series of processes described above may be performed by hardware or software. When the series of processes is performed by software, a program included in the software is installed on a computer. Here, examples of the computer include a computer incorporated into dedicated hardware, and a computer, such as a general-purpose computer, that can perform various functions by various programs being installed thereon.

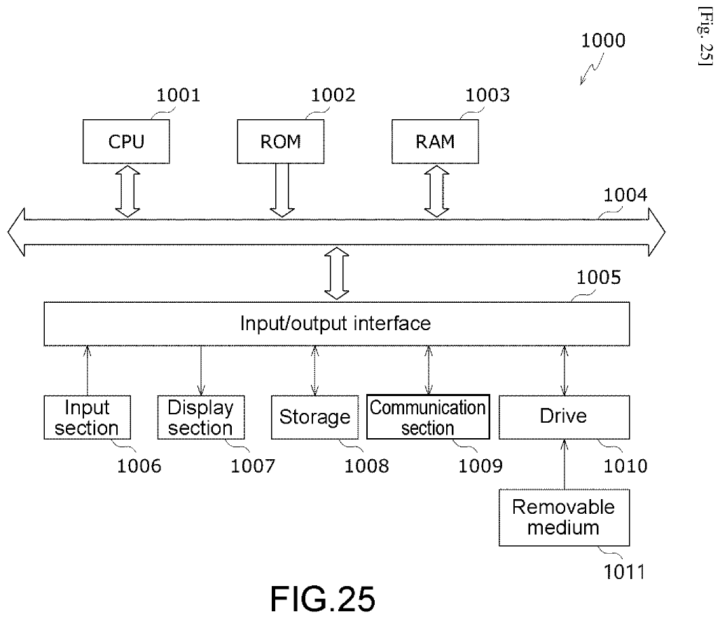

FIG. 25 is a block diagram of an example of a configuration of hardware of a computer that performs the series of processes described above using a program.

In a computer 1000, a central processing unit (CPU) 1001, a read only memory (ROM) 1002, and a random access memory (RAM) 1003 are connected to one another through a bus 1004.

An input/output interface 1005 is further connected to the bus 1004. An input section 1006, an output section 1007, a recording section 1008, a communication section 1009, and a drive 1010 are connected to the input/output interface 1005.

The input section 1006 includes, for example, an input switch, a button, a mi-crophone, and an imaging element. The output section 1007 includes, for example, a display and a speaker. The recording section 1008 includes, for example, a hard disk and a nonvolatile memory. The communication section 1009 includes, for example, a network interface. The drive 1010 drives a removable medium 1011 such as a magnetic disk, an optical disk, a magneto-optical disk, or a semiconductor memory.

In the computer 1000 having the configuration described above, the series of processes described above are performed by, for example, the CPU 1001 loading, into the RAM 1003, a program recorded in the recording section 1008 through the input/output interface 1005 and the bus 1004 and executing the loaded program.

For example, the program performed by the computer 1000 (the CPU 1001) can be provided in a state of being recorded in the removable medium 1011 that is, for example, a package medium. Further, the program can be provided through a wired or wireless transmission medium such as a local area network, the Internet, or digital satellite broadcasting.

In the computer 1000, the program is installed on the recording section 1008 through the input/output interface 1005 by attaching the removable medium 1011 to the drive 1010. Further, the program can be received in the communication section 1009 through a wired or wireless transmission medium to be installed on the recording section 1008. Moreover, the program can be installed on the ROM 1002 or the recording section 1008 in advance.

Note that the program performed by a computer may be a program in which processes are chronologically performed in accordance with the order described herein, or may be a program in which processes are performed in parallel or a process is performed at a necessary timing such as a timing of calling.

Further, as used herein, a system refers to a set of a plurality of constituent elements (such as devices and modules (components)), and whether all of the constituent elements are in a single housing is no object. Thus, a plurality of devices accommodated in separate housings and connected to one another through a network, and a single device in which a plurality of modules is accommodated in a single housing are both systems.

Furthermore, the embodiment of the present technology is not limited to the embodiments described above, and various modifications may be made thereto without departing from the scope of the present technology.

For example, the present technology may also have a configuration of cloud computing in which a plurality of devices shares tasks of a single function and works collaboratively to perform the single function through a network.

Moreover, the respective steps described using the flowcharts described above may be shared by a plurality of devices to be performed, in addition to being performed by a single device.

Further, when a single step includes a plurality of processes, the plurality of processes included in the single step may be shared by a plurality of devices to be performed, in addition to being performed by a single device.

### Example of Combination of Configurations

The present technology may also take the following configurations.

(1) An information processing apparatus including a display controller that controls a display of a flow by displaying, on a topology of a network, a symbol indicating data that flows in the network, the flow being the flowing of the data in the network, and changes a display mode for the symbol for each type of the data.

(2) The information processing apparatus according to (1), in which

the display controller controls a display of an entire topology and a display of a partial topology, the entire topology corresponding to the entire network, the partial topology corresponding to a portion of the network.

(3) The information processing apparatus according to (2), in which

the partial topology is a topology of a portion related to some of the flows in the network.

(4) The information processing apparatus according to (3), in which the some of the flows are flows that each pass through a specific device, a specific switch, or a specific interface in the network.

(5) The information processing apparatus according to (3) or (4), in which the some of the flows are flows that each correspond to a specific type of data.

(6) The information processing apparatus according to any one of (2) to (5), in which when a portion of the entire topology is specified, the display controller performs control such that the partial topology related to a flow that passes through the specified portion is displayed.

(7) The information processing apparatus according to any one of (2) to (6), in which when the display controller displays the entire topology, the display controller unifies display modes for the symbols, and when the display controller displays the partial topology, the display controller differentiates among the display modes for the symbols according to a type of the data.

(8) The information processing apparatus according to any one of (2) to (7), in which the display controller changes a layout in which a topology is displayed, according to whether the displayed topology is the entire topology or the partial topology.

(9) The information processing apparatus according to any one of (1) to (8), in which according to a display size or a display magnification of the topology, or according to the number of types of the data, the display controller switches between unifying display modes for the symbols and differentiating among the display modes for the symbols according to a type of the data.

(10) The information processing apparatus according to any one of (1) to (9), in which the display controller controls a display of the topology such that an anomalous portion in which an anomaly has been detected in the network is highlighted.

(11) The information processing apparatus according to (10), in which the display controller controls a display of a partial topology that is a topology corresponding to a portion related to the anomalous portion in the network.

(12) The information processing apparatus according to (11), in which when the anomaly has been detected in the network, the display controller starts the display of the partial topology.

(13) The information processing apparatus according to any one of (1) to (12), in which

the display controller controls a report of an anomaly detected in the network.

(14) The information processing apparatus according to any one of (1) to (13), in which

using the topology and the symbol, the display controller controls a display of a current state of the network and a display of a state of the network at a specified date and time in times past.

(15) The information processing apparatus according to (14), in which when an anomaly has been detected in the network in a state in which the flow in the network in times past is displayed, the display controller performs control such that the current state of the network is displayed.

(16) The information processing apparatus according to any one of (1) to (15), in which a type of the data is classified by at least one of an address of a transmission destination of the data or an address of a transmission source of the data.

(17) The information processing apparatus according to any one of (1) to (16), in which

the information processing apparatus controls a display of a list of information related to a plurality of the flows each corresponding to a plurality of types of the data.

(18) The information processing apparatus according to any one of (1) to (17), in which

the information processing apparatus controls a display of states of a switch and a device that are related to a flow selected from a plurality of the flows each corresponding to a plurality of types of the data.

(19) An information processing method that is performed by an information processing apparatus, the information processing method including:

controlling a display of a flow by displaying, on a topology of a network, a symbol indicating data that flows in the network, the flow being the flowing of the data in the network; and changing a display mode for the symbol for each type of the data.

(20) A program that causes a computer to perform a process including:

controlling a display of a flow by displaying, on a topology of a network, a symbol indicating data that flows in the network, the flow being the flowing of the data in the network; and changing a display mode for the symbol for each type of the data.

Note that the effects described herein are not limitative but are merely illustrative, and other effects may be provided.

It should be understood by those skilled in the art that various modifications, combinations, sub-combinations and alterations may occur depending on design re-quirements and other factors insofar as they are within the scope of the appended claims or the equivalents thereof.

### REFERENCE SIGNS LIST

1 Communication system
11T-1 to 11T-m Transmission device
11R-1 to 11R-n Reception device
12 Switch group
13 Server
21 Network
31 Data acquisition section
32 Model building section
33 Analyzer
35 Communication section
42 Display controller
43 Display section
44 Communication section

1. An information processing apparatus comprising a display controller that controls a display of a flow by displaying, on a topology of a network, a symbol indicating data that flows in the network, the flow being the flowing of the data in the network, and changes a display mode for the symbol for each type of the data.

2. The information processing apparatus according to claim 1, wherein the display controller controls a display of an entire topology and a display of a partial topology, the entire topology corresponding to the entire network, the partial topology corresponding to a portion of the network.

3. The information processing apparatus according to claim 2, wherein the partial topology is a topology of a portion related to some of the flows in the network.

4. The information processing apparatus according to claim 3, wherein the some of the flows are flows that each pass through a specific device, a specific switch, or a specific interface in the network.

5. The information processing apparatus according to claim 3, wherein the some of the flows are flows that each correspond to a specific type of data.

6. The information processing apparatus according to claim 2, wherein when a portion of the entire topology is specified, the display controller performs control such that the partial topology related to a flow that passes through the specified portion is displayed.

7. The information processing apparatus according to claim 2, wherein when the display controller displays the entire topology, the display controller unifies display modes for the symbols, and when the display controller displays the partial topology, the display controller differentiates among the display modes for the symbols according to a type of the data.

8. The information processing apparatus according to claim 2, wherein the display controller changes a layout in which a topology is displayed, according to whether the displayed topology is the entire topology or the partial topology.

9. The information processing apparatus according to claim 1, wherein according to a display size or a display magnification of the topology, or according to the number of types of the data, the display controller switches between unifying display modes for the symbols and differentiating among the display modes for the symbols according to a type of the data.

10. The information processing apparatus according to claim 1, wherein the display controller controls a display of the topology such that an anomalous portion in which an anomaly has been detected in the network is highlighted.

11. The information processing apparatus according to claim 10, wherein the display controller controls a display of a partial topology that is a topology corresponding to a portion related to the anomalous portion in the network.

12. The information processing apparatus according to claim 11, wherein when the anomaly has been detected in the network, the display controller starts the display of the partial topology.

13. The information processing apparatus according to claim 1, wherein the display controller controls a report of an anomaly detected in the network.

14. The information processing apparatus according to claim 1, wherein using the topology and the symbol, the display controller controls a display of a current state of the network and a display of a state of the network at a specified date and time in times past.

15. The information processing apparatus according to claim 14, wherein when an anomaly has been detected in the network in a state in which the flow in the network in times past is displayed, the display controller performs control such that the current state of the network is displayed.

16. The information processing apparatus according to claim 1, wherein a type of the data is classified by at least one of an address of a transmission destination of the data or an address of a transmission source of the data.

17. The information processing apparatus according to claim 1, wherein the information processing apparatus controls a display of a list of information related to a plurality of the flows each corresponding to a plurality of types of the data.

18. The information processing apparatus according to claim 1, wherein the information processing apparatus controls a display of states of a switch and a device that are related to a flow selected from a plurality of the flows each corresponding to a plurality of types of the data.

19. An information processing method that is performed by an information processing apparatus, the information processing method comprising:
controlling a display of a flow by displaying, on a topology of a network, a symbol indicating data that flows in the network, the flow being the flowing of the data in the network; and
changing a display mode for the symbol for each type of the data.

20. A program that causes a computer to perform a process comprising:
controlling a display of a flow by displaying, on a topology of a network, a symbol indicating data that flows in the network, the flow being the flowing of the data in the network; and
changing a display mode for the symbol for each type of the data.
